(19) United States
(12) Patent Application Publication
(10) Pub. No.: US 2016/0081481 A1
(43) Pub. Date: Mar. 24, 2016

(54) FOLDABLE CUSHIONED SEAT

(71) Applicant: Glenda King, Park Falls, WI (US)

(72) Inventor: Glenda King, Park Falls, WI (US)

(21) Appl. No.: 14/489,808

(22) Filed: Sep. 18, 2014

(51) Int. Cl. A47C 7/02; A47C 7/42

(52) U.S. Cl. CPC A47C 7/021; A47C 7/42; A61G 2005/1091

(57) ABSTRACT

A foldable cushioned seat comprising a seat cushion placed upon a seat, where the seat cushion includes a top surface, and where the seat cushion is filled with a material; a back cushion positioned against a back rest, where the back cushion includes a top surface, and where the back cushion is filled with a material; a connector between the seat cushion to the back cushion; and a secured opening on both the seat cushion and the back cushion, where the secured opening enables removal of the material.

### BACKGROUND OF THE INVENTION

1. Field of the Invention

The present invention relates to a cushioned seat that is positioned on a chair thereby supporting and elevating the user.

2. Description of Related Art

Typically, after surgery a patient is very sore around their incision site. The area is usually tender to touch causing the patient to avoid contact with the area. Additionally, they must take care not to irritate the skin by the incision to ensure healthy healing. Because of the soreness during recuperation, the patient usually has trouble with mobility, either movement around a room or even movement upon the bed or chair upon which they are resting. Similarly elderly individuals lose their mobility requiring more time and effort while walking, and performing routine tasks. Even the most mundane tasks like sitting in a chair can be a painful and laborious endeavor.

To assist with movement for those with limited mobility, several devices have been developed. For example, motorized lifting chairs are available which raise the person from a seated position so that little to no effort is required to stand. While these chairs are convenient, they are very expensive to own, especially when the use is limited to only recovery. Alternatively, most hospital chairs and beds have handrails so that the patient can easily lower themselves onto the seat. The patient is able to lower themselves at their own pace and even use the rail for momentum while standing. While the rails are useful, they are not widely available on all seats, thus limiting their usage.

Therefore it would be beneficial in the art to provide a device that assists a patient when positioning themselves on a seat. It would also be desirable in the art to provide a device that is easily transferrable to any seat used by the patient.

### SUMMARY OF THE INVENTION

In view of the foregoing disadvantages inherent in the prior art, the general purpose of the present invention is to provide a foldable cushioned seat to position upon a seat, configured to include all of the advantages of the prior art, and to overcome the drawbacks inherent therein.

Accordingly, an object of the present invention is to provide a foldable, cushioned seat including a connected seat cushion and back cushion, which helps a user sit and rise from a chair.

Another object of the present invention is to provide a foldable, cushioned seat including an internal support within the seat cushion to maintain structure while sitting on the seat.

To achieve the above objects, in an aspect of the present invention, a foldable cushioned seat is described comprising a seat cushion placed upon a seat, where the seat cushion includes a top surface, and where the seat cushion is filled with a material; a back cushion positioned against a back rest, where the back cushion includes a top surface, and where the back cushion is filled with a material; a connector between the seat cushion to the back cushion; and a secured opening on both the seat cushion and the back cushion, where the secured opening enables removal of the material.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a foldable cushioned seat in accordance with an exemplary embodiment of the present invention; and

FIG. 2 depicts a side view of a foldable cushioned seat on a chair in accordance with an exemplary embodiment of the present invention.

Like reference numerals refer to like parts throughout the description of several views of the drawings.

### DETAILED DESCRIPTION OF THE DRAWINGS

The present invention relates to a cushioned seat that is positioned on a chair thereby supporting and elevating the user. The present invention provides a foldable cushioned seat to facilitate getting up from and easing into furniture. The foldable cushioned seat includes two cushions attached with a central connection. The bottom cushion may include an inner support for greater stability while seated. When positioned on a chair, couch or recliner the foldable cushioned seat provides additional inches to the chair making sitting and rising easier and more comfortable. This is especially helpful to patients and elderly users allowing them to exert less effort while sitting, resting and standing.

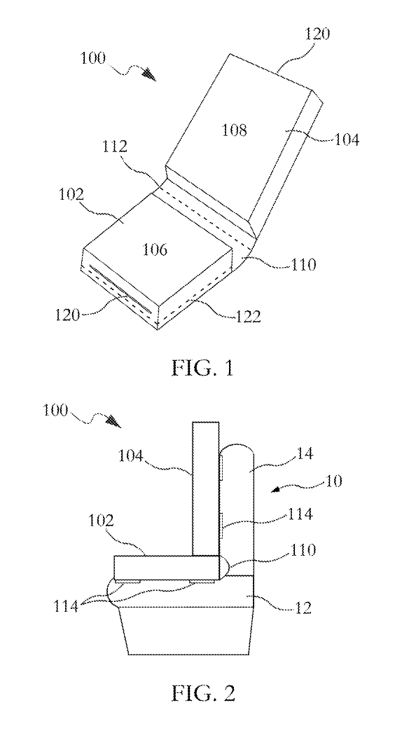

Turning now descriptively to the drawings, referring to FIG. 1, a foldable cushioned seat 100 is shown in accordance with an exemplary embodiment of the present invention. The foldable cushioned seat 100 includes a seat cushion 102 attached to a back cushion 104. The seat cushion 102 elevates its top surface 106 approximately 1-6 inches above the seat upon which it rests. Similarly, a top surface 108 of the back cushion 104 extends approximately 1-6 inches from the surface upon which it rests. The material covering the seat cushion 102 and the back cushion 104 may be a vinyl, plastic, cotton, silk, leather, or other durable fabric.

The seat cushion 102 and the back cushion 104 are joined with a connector 110. The connector 110 is a portion of material that keeps the cushions 102, 104 together while the user is seated upon the foldable, cushioned seat 100. The connector 110 may be separated with a fastener 112 to detach the seat cushion 102 from the back cushion 104. The fastener 112 may be a hook and loop fastener, a zipper, a plurality of buttons, snaps or clips.

The cushions 102, 104 may be filled with foam or cotton pillow for a soft yet supportive feel beneath the user and against their back. The pillow may be removed, replaced and exchanged from the seat cushion 102 and the back cushion 104 through a secured opening 120. Depending on the needs of the user, different firmness and textures of the pillow may be used within the cushions 102, 104. The secured opening 120 may be a hook and loop fastener or a zipper to ensure that the pillow does not escape during use. Within the seat cushion 102 may be a support 122. The support 122 may be inserted and removed through the secured opening 120 as preferred and needed by the user. The support 122 may be a plastic, wood or aluminum board that when positioned within the seat cushion 102 to prevent the cushion 102 from distorting while the user is seated.

Referring now to FIG. 2, a side view of a foldable, cushioned seat 100 on a chair 10 is shown in accordance with an exemplary embodiment of the present invention. The seat cushion 102 is positioned upon the seat 12 of the chair 10 while the back cushion 104 is positioned against the back rest 14. The seat cushion 102 and the back cushion 104 may be held in place with a plurality of securing strips, where the strips are hook and loop fasteners 114. The securing strips 114 ensure that the cushions 102, 104 do not move or shift while the user is seated. The seat cushion 102 elevates the seat 12 to reduce the distance the user has to travel when sitting. Likewise, the back cushion 104 shortens the distance to the back rest 14. The foldable cushioned seat 100 may rest against the chair 10 as illustrated, but may also be used upon a couch, recliner, car seat, or any seats necessitated by the user. This way the user is able to more easily sit and rise from the chair 10 without the struggle commonly faced when approaching a low or ill-fitting chair.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A foldable cushioned seat comprising:
a. a seat cushion placed upon a seat, where the seat cushion includes a top surface, and where the seat cushion is filled with a pillow and includes an internal support;
b. a back cushion positioned against a back rest, where the back cushion includes a top surface, and where the back cushion is filled with a pillow, where the seat cushion and the back cushion include a plurality of securing strips wherein the securing strips are hook and loop fasteners;
c. a connector between the seat cushion to the back cushion; and
d. a secured opening on both the seat cushion and the back cushion, where the secured opening enables removal of the pillow.

2. The foldable cushioned seat according to claim 1, where the connector includes a fastener, where the fastener enables separation of the seat cushion from the back cushion.

3. The foldable cushioned seat according to claim 2, where the fastener is one of at least a hook and loop fastener, a zipper, a plurality of clips, buttons or snaps.

4. The foldable cushioned seat according to claim 1, where the secured opening is a hook and loop fastener.

5. The foldable cushioned seat according to claim 1, where the secured opening is a zipper.

6. (canceled)

7. (canceled)

8. The foldable cushioned seat according to claim 1, where the pillows within both the seat cushion and the back cushion are exchangeable with one or more pillows of varying firmness.
